(19) United States
(12) Patent Application Publication
(10) Pub. No.: US 2025/0274332 A1
(43) Pub. Date: Aug. 28, 2025

(54) High throughput Communications system for End of Train and Head of Train Communications

(71) Applicant: Meteorcomm, LLC, Renton, WA (US)

(72) Inventors: Thanongsak Himsoon, Kent, WA (US); Wipawee Siriwongpairat, Kent, WA (US); Mark Davies, Renton, WA (US)

(21) Appl. No.: 19/033,443

(22) Filed: Jan. 21, 2025

Related U.S. Application Data
(60) Provisional application No. 63/622,990, filed on Jan. 19, 2024.

(51) Int. Cl. H04L 27/36; B61L 15/00

(52) U.S. Cl. CPC H04L 27/361; B61L 15/0027; B61L 15/0054; B61L 15/0072

(57) ABSTRACT

Disclosed below are various methods and apparatus that enable a more efficient EOT/HOT communication system for a 12.5 kHz channel in the 450 MHz frequency band, which complies with legal and regulatory limits and emissions mask requirements. Such a system is capable of data rights higher than the 1200 bps of the legacy 450 MHz radios that use the legacy FFSK-over FM modulation. Examples of higher data rate modulations include, but not limited to, FFSK, DQPSK, and D8PSK modulations.

### RELATED APPLICATIONS

This application claims priority to U.S. provisional application No. 63/622,990, filed Jan. 19, 2024, which is incorporated herein by reference for all purposes.

### FIELD OF INVENTION

The disclosure relates generally to radio frequency communication systems for use by railroads to send message wirelessly between an end of a train and a head of a train.

### BACKGROUND

Modern railway operations, particularly those of class I freight railroads with long trains, require various electronic devices for monitoring, signaling, and controlling trains and devices located on trains. One such device is an “end of train” (EOT) unit or device attached to the rear of the last car of a train. Because the final car in a train may change at any point in a trip, the EOT unit usually needs to be relatively easily and quickly removed by train personnel and attached to the new final car.

An EOT unit is, therefore, typically an integrated device with a structure and enclosure that facilitates its attachment and removal from the train car, protects the equipment, and discourages unauthorized access to the equipment. EOT units have evolved to handle more functions and are now required by regulation on trains that go over 30 miles per hour and operate on heavy grades. EOT units now include additional equipment or components that monitor or interoperate with one or more subsystems on the train and perform signaling and communication functions. For example, one of the functions of modern EOT units is to monitor the train's braking system pressure at the last car and report it or a loss of pressure to a system in the head of train area, which is typically the lead locomotive. If there is adequate pressure at the train's last car, the cars in front of it will have adequate pressure. Another function of an EOT is to provide emergency braking control to the rear section of a train. EOT units are thus capable of receiving an emergency braking signal from a HOT device. EOT units may also, for example, include GPS or other components for detecting geolocation to identify the end of train, train movement, and train speed.

An end-of-train communications system communicates train handling and safety information between one or more railroad applications located in the EOT area and one or more railroad applications running on one or more computers located the HOT area at the front of the train, which typically a lead locomotive. For purposes of the following description, a railroad application refers to one or more programs running on one or more computers located in the EOT unit or HOT. It may also include associated hardware systems.

This communication system is wireless. One or more radios in the EOT and one or more radios in the HOT that transmit messages to each other. The term radio will generally refer to a unit that includes a transceiver (a transmitter and receiver) for transmitting and receiving RF signals that carry data between the EOT and HOT. However, it may refer to a unit that is just a receiver or just a transmitter, or a combination of such units.

EOT/HOT communications are schematically illustrated by FIG. 1, which contains a nonlimiting representation of a freight train 100 on a track 101 with an end-of-train (EOT) area 102 located at the end of the last car of the train and a head of train (HOT) area 104 at the front of the train. Arrow 106 represents direct RF two-way communications between radios (not shown) in the EOT and HOT using an EOT communication system.

Wireless messages transmitted by radios in an EOT unit and an HOT area in North America are sent over certain licensed channels in the 450 MHz band licensed for this purpose. The 450 MHz band refers to a band of frequencies generally between 450 MHz and 470 MHz under the current United States Federal Communication Commission's frequency allocation plan. The use of these frequencies is reserved for private land mobile radio services and are subject to the regulations of 47 C.F.R. part 90. Current regulations requires that transmissions in the 450 MHz frequency band be limited to narrowband channels, with bandwidths of 12.5 kHz or lower. This narrowband requirement intended to promote efficient use of the spectrum in this band. Radios for EOT/HOT communications therefore face substantial constraints that limit power and ERP and thus also data rates.

Transmissions for EOT and HOT radios using these licensed channels are currently expected to conform to the S-9152 standard in the Manual of Standards and Recommended Practices published by the Association of American Railroads (AAR). Current EOT communication systems conforming to S-9152 transmit wireless digital data packets in a 12.5 KHz analog FM (frequency modulated) radio channel in the 450 MHz frequency band. Under the AAR S-9152 standard, the digital data modulates the frequency of a carrier signal using a digital modulation method known as continuous phase fast frequency shift keying (FFSK) over-FM at a transmit data rate of 1200 bps.

### SUMMARY

Disclosed below are various methods and apparatus that enable a more efficient EOT/HOT communication system for a 12.5 kHz channel in the 450 MHz frequency band, which complies with legal and regulatory limits and emissions mask requirements. Such a system is capable of data rates higher than the 1200 bps of the legacy 450 MHz radios that use the legacy FFSK-over FM modulation. Examples of higher data rate modulations include, but not limited to, FFSK, DQPSK, and D8PSK modulations.

The implementation of one or more of the methods or apparatus by 450 MHz radios of an EOT/HOT communications system can enable them to handle an increasing amount of traffic between EOT and HOT areas and the increasing lengths of freight trains.

EOT/HOT communications are schematically illustrated by FIG. 1, which contains a nonlimiting representation of a freight train 100 on a track 101 with an end-of-train (EOT) area 102 located at the end of the last car of the train and a head of train (HOT) area 104 at the front of the train.

### BRIEF DESCRIPTION OF THE FIGURES

FIG. 1 schematically illustrates a nonlimiting example of a freight train with an end-of-train (EOT) area and a head of train (HOT) area with wireless two-way communications between radios in the EOT and HOT.

FIG. 2 schematically illustrates a representative example of a communication for transporting application messages exchanged between a railroad application in the EOT area and a railroad application in the HOT area.

FIG. 3 illustrates a representative, nonlimiting example of a structure for a wireless packet for legacy 450 MHz radios and higher data rate 450 MHz radios.

FIG. 4 illustrates a representative example of a channel access method or process of a channel access scheme.

FIG. 5 illustrates an example of a 450 MHz radio configured for legacy FFSK-over-FM modulation with a transmit data rate of 1200 bps.

FIG. 6 represents a frequency spectrum of an FFSK-over-FM waveform at a symbol rate of 1200.

FIG. 7 schematically illustrates a representative example of a higher data rate 450 MHZ radio with a continuous waveform produced the FFSK modulator

FIG. 8 represents a frequency spectrum of an FFSK wave form at a symbol rate of 1200.

FIG. 9 schematically illustrates a representative example of a higher data rate 450 MHZ radio with continuous waveform modulated using an advanced FFSK modulation

FIG. 10 schematically illustrates a representative example of a higher data rate 450 MHZ radio using DQPSK-over-FM modulation.

FIG. 11 schematically illustrates a representative example of a higher data rate 450 MHZ using DQPSK modulation.

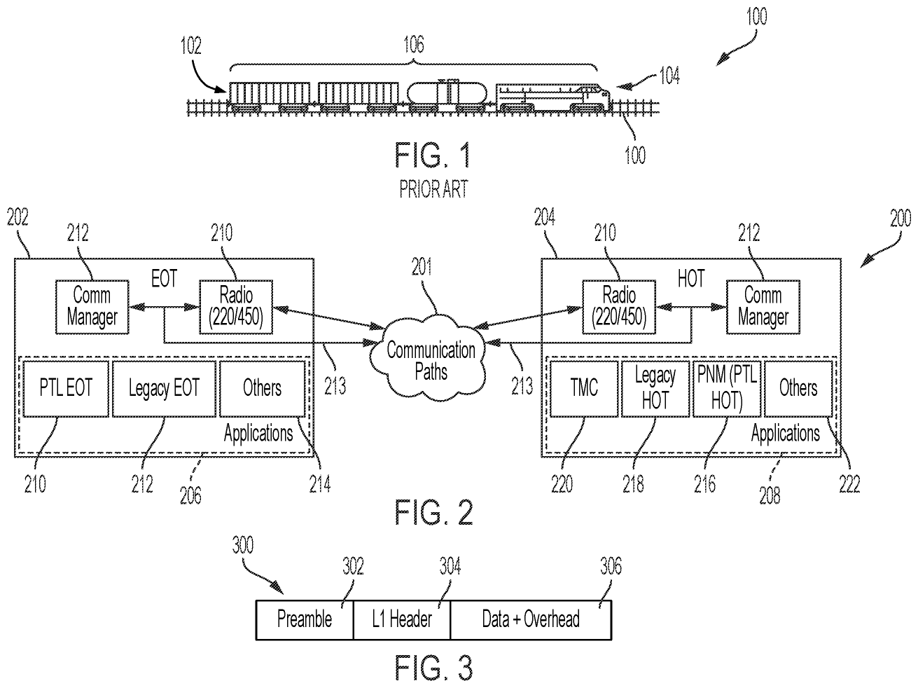

### DETAILED DESCRIPTION

In the following description, like numbers refer to like elements.

FIG. 2 schematically illustrates communication systems in an end of train (EOT) area 202 of a train and a head of train (HOT) area 204 of the train for transporting application messages exchanged between railroad applications in the EOT area and a railroad application in the HOT area over one or more communication paths represented by cloud 201. This disclosure assumes that there are only two train areas, an HOT and an EOT. The HOT area is usually defined by the lead locomotive and the EOT area is usually end of train or EOT unit on the opposite end of the train from the locomotive. However, there could be other areas of the train where railroad applications are hosted. Such areas can be treated as an EOT area for purposes of this disclosure.

The figure, which is representative, illustrate the possibility of multiple EOT applications 206 in the EOT area and multiple HOT applications 208 in the HOT area. The railroad applications in one train area exchange messages, represented by digital data, with railroad applications in the other train area through a communications manager 212 for that area. There is at least one communication manager in each EOT area and HOT area. Multiple communication managers in each area are possible, with different communication managers serving different applications.

A railroad application, for purposes of this disclosure, refers to a component of a system that supports railroad operations and requires the availability of a message transport to send and/or receive messages between remote components of the system or another railroad system. Representative, non-limiting examples of EOT applications may include an end of train point protection (PTCL EOT) application 210 and a legacy EOT application 212. Other applications 214 are possible. Representative examples of HOT applications include heat of train point protection, PNM (PTL HOT) 216, legacy HOT applications 218, and train management computer (TMC) applications 220. Other HOT possible HOT applications are represented by block 222 The railroad applications are implemented at least in part using computing devices or systems that are programmed using software or firmware to perform processes that support the application. The computing devices or systems can be embedded or general purpose. Such computing device or system will typically include memory that stores programs of instructions and one or more processors that read and perform the instructions. The computing device or system can be an embedded system. The processors can be one or more general purpose microprocessors, one or more special purpose processors, or a combination. The hardware comprising the computing devices or system may, alternatively or in addition, include programmable hardware circuits such as field programmable gate arrays (FPGA) that are programmed using software configurations to carry out the processes, application specific integrated circuits, other types of circuits, or combinations of them.

The communications manager in a train area manages communications between railroad applications in its area and one or more wireless transports for transporting the message along a communication path. Cloud 201 represents collectively one or more communications paths to the other train area (the destination area) that might be available for a given train.

A communications manager can be implemented, for example, using software or firmware, or by programmable hardware. For example, a communication manager may be implemented as a discrete hardware unit. However, in may also be hosted by a computing system or an embedded computing system in the area, including by the computing system hosting one or more of the railroad applications or embedded computing systems a train management computer (HOT area), or a radio unit.

Representative examples of communication paths that could be available for communicating between EOT and HOT areas of a given train include those that use a wireless transport provided by one or more one or more radios 210 and those using other networks for transport, which are represented by line 213. Possible paths using the one or more radios could include one or more direct paths on a radio link between a radio in each of the HOT and EOT train area, one or more indirect paths through an intermediate, repeating radio, and one or more indirect paths using wireless train control network. Paths using other networks include wireless transport on Wi-Fi, cellular, satellite, and such networks. A given EOT or HOT area does not need, and is not expected, to be configured—meaning to have equipment configured for use—to have access all the wireless transports for all the communication paths mentioned above or to be capable of routing application messages over all the communication paths, or that all of them be available. It may be configured to communicate only on one communication path. However, if an EOT or HOT area is configured to be able to send an application message over more than one path, a communications manager or other process may have the option of selecting from them a path based on predetermined selection criteria or changing the path based on predetermined criteria.

To send a message to a destination railroad application in another train area, a railroad application generates and provides the message to a communications manager. If the communications manager is on another host in the area, the railroad application will send the message in one or more IP packets on the area's local area network to the communication manager. The communications manager will then set up and route the message to a wireless transport or network based on one or more a communication paths known for delivering the message to the destination area. The communication path can be configured or set up manually. It may also be learned. If more than one communication path to the destination train area is known to the communications manager, it selects one of the communications paths and routes the message to a wireless transport accordingly.

At least one of the one or more radios 210 in each area provides wireless message transport using a channel in the 450 MHz frequency band, which includes a range of frequencies between 450 MHz and 455 MHz for private land mobile use. Governmental regulations in the US currently require narrowband channels (not more than 12.5 KHz) for this use.

The one or more radios 210 are, optionally, also configured to be capable of transmitting and/or receiving in channels in other one or more other frequency bands that are used by wireless train control networks for transporting train control messages such interoperable positive train control (PCT). Wireless train control networks may also be used to transport message for other railroad applications. ITCnet® is a wireless interoperable train control network in the United States and Canada to transport interoperable Positive Train Control (PCT) and other railroad application messages. It operates in 220 MHz frequency band, which are frequencies in the range of 220-222 MHz. Radios capable of transmitting and receiving in the 220 MHz frequency band will be referred to as 220 MHz radios. If such radios are configured to be capable of transmit using protocols from the ITCnet Common Air Interface protocol and related protocols and specifications published by Meteorcomm, LLC, the radio will be referred to as an ITC 220 MHz radio. Unless the context clear indicates otherwise, ITC 220 MHz radios are representative examples of radios for train control wireless networks for purposes of this disclosure.

In the representative example of FIG. 2, the one or more radios 210 in each area are labelled to indicate that they are “220/450” to indicate that the radios are capable of functioning as a 450 MHz radio, or a 220 MHz radio, or possibly both a 450 MHz radio and a 220 MHz radio. The one or more radios 210 for a given area may, for example, include either one or more 450 MHz radios or one or more 220 MHz radios. The at least one operating as 450 MHz radio and at least one operating as a 220 radio. The radio may comprise a single unit that can be configured to transmit and/or receive at 450 MHz—in which case it is a 450 MHz radio—or a 220 MHz, in which case it is 220 MHz radio, or both. The one or more radios may instead, or also include, one or more radios operating in frequency bands other than the 450 MHz and 220 MHz frequency bands. the same time.

In one embodiment, each of the one or more radios 210 is in this example comprised of a transceiver operating in a half-duplex mode. It may be capable of transmitting and receiving on multiple channels. Each may transmit on one channel and receive on another channel.

At least one 450 MHz radio in the EOT and HOT train areas is configured to use a modulation scheme supporting higher data rates than the legacy modulation scheme used by legacy analog 450 MHz radios, which is FFSK-over-FM modulation with data rate of 1200 bps.

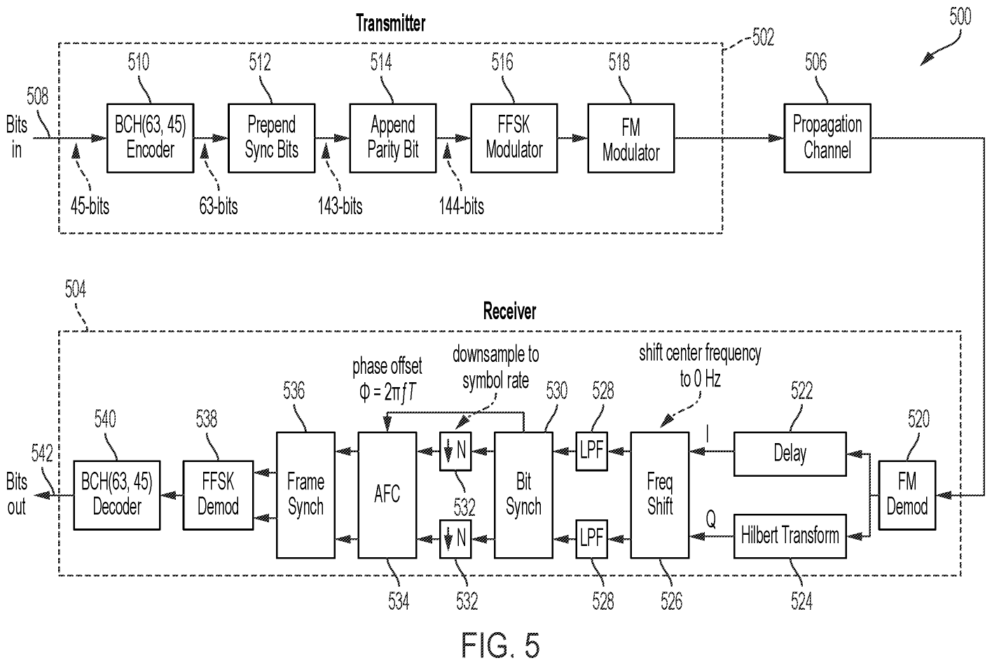

Use of the different modulation scheme enables more efficient transmission of the message data and thus transmission of message data at higher data rates on channel width of 12.5 MHz while still complying with legal regulatory limits emissions masks and achieving acceptable error rates for delivery of time-sensitive railroad application messages between the EOT and HOT train areas. Examples of such higher data rate modulation schemes include but are not limited to FFSK, DQPSK, Pi/4 DQPSK, and D8PSK modulation schemes. Representative examples of radios and higher data modulation schemes are described below in connection with FIGS. 5 to 11.

Each of the one or more radios 210 in this example can be implemented as a software defined radio (SDR). However, an SDR is not required. In an SDR, some of the functions that were once realized using only hardware circuits are implemented using software, such as programs of instructions that are executed by general purpose processors and/or specialized processors such as digital signal processors (DSPs), as well as software that configures programmable hardware, such as field programmable gate arrays (FPGA). One of many possible benefits of an SDR is that multiple radios can be implemented on a single hardware unit. Thus, each of the one or more radios 210 can be, but does not have to be, implemented as an SDR on a single hardware unit. An embodiment of the one or more radios 210 in the EOT or HOT train area of the representative example of FIG. 2 may be implemented as a single SDR unit, the configuration of which can be changed to operate in different frequency bands, use different modulation schemes and data rates, or change other transmit or receive parameters.

When one of the one or more radios 210 receives over its local area network interface one or more IP packets containing a railroad application message from the communications manager, it will encode the message data for error correction and queue it for transmission in one or more wireless packets. The message data includes the application message and any overhead such as headers required for delivery of the message. Adding bits for error correction lowers the data transmission rate.

FIG. 3 illustrates a representative, nonlimiting example of a basic structure for a wireless packet 300 for legacy 450 MHz radios, which may also be used by higher data rate 450 MHz disclosed below. Each wireless packet 300 starts with preamble 302 followed by, for example, a physical or layer 1 (L1) header 304 and a portion 306 that includes message data and overhead information. The L1 header is used to transmit physical layer information about the data packet. Physical layer information may include, for example, any one or more of the following: the data rate that at which the data in portion 306 is encoded, the type of forward error correction (FEC) used for encoding, and the length of the data in portion 306. The overhead part of portion 306 may include information on any one or more of the following: the packet type; a layer 2 address for the source radio and, optionally, the destination radio; forward error correction (FEC) codes; and cyclic redundancy check (CRC) information. Different packet types may require or optionally allow for additional headers and other predefined portions for wireless packets of that type and define for data fields within headers and other portions of a wireless packet.

The L1 header is, in one embodiment, encoded and transmitted a predetermined base data rate. The message data and overhead in portion 306 can be transmitted a different rate, including at a higher data rate supported by higher data rate modulation. The date rate for the message data and overhead in portion 306 may, optionally, be set based on packet type.

The use of packet types is optional unless otherwise noted in the apparatus and methods described in this disclosure. Representative and non-limiting examples of packet types that may be defined include: a unicast data packet; a broadcast data packet; and an acknowledgement packet. Additional packet types could be defined.

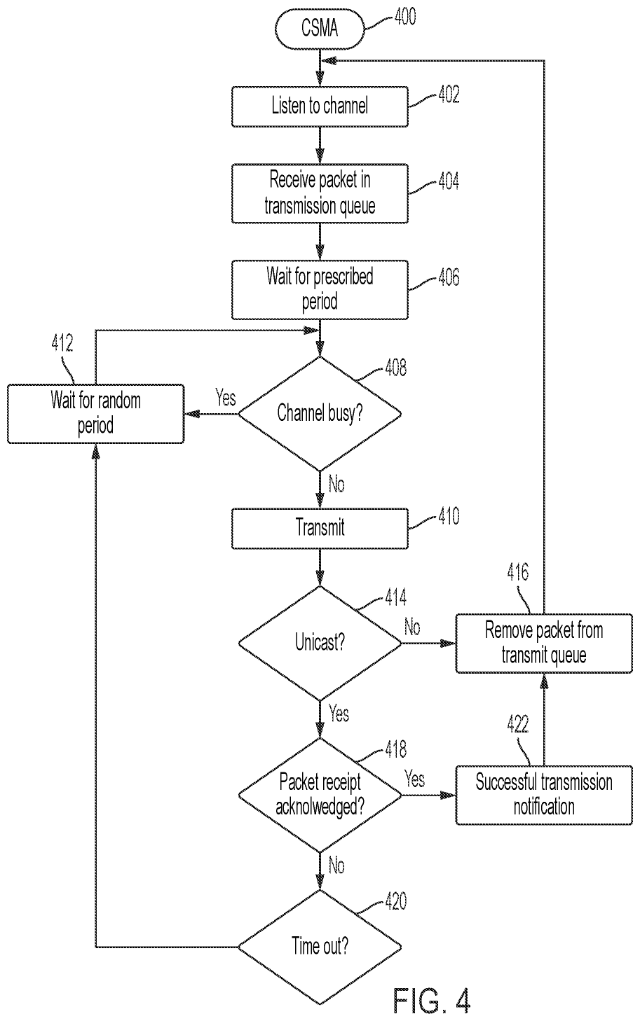

FIG. 4 illustrates a representative example of a channel access method or process of a channel access scheme that may be used with a digital packet 450 MHz radio in the HOT and EOT, such radios 210, configured with any one or more of the modulation schemes described below.

A legacy EOT/HOT radio is configured to transmit a packet immediately after it receives it for transmission, without checking the status of the channel. Therefore, a legacy 450 MHz radio could transmit a packet at the same time as another radio on the same channel, resulting in a packet collision. A packet collision causes unsuccessful transmission. Configuring a 450 MHz radio digital packet radio to use an access scheme such as the one described below reduces the chance of a packet collision, which checks that the channel is idle before transmitting, increases reliability of the RF communication.

Because the channel in the 450 MHz frequency band must be shared by 450 MHz radios in the HOT and EOT, each of the radios are configured to access the radio frequency channel using process that reduces “collisions.” A collision occurs when transmissions on the same radio frequency channel from two or more radios interfere with each other. The process relies on a Carrier Sense Multiple Access (CSMA) scheme. FIG. 4 illustrates a representative channel access method 400 for a CSMA scheme that may be used by the 450 MHz radios in the HOT and ETO.

As represented by step 402, each radio listens to the channel. This means that it is receiving and processing signals using its receiver that are picked up by its antenna. When a packet is placed in its transmission queue at step 404, it waits a predetermined period as indicated by step 406 and then determines at step 408 whether the channels is idle or busy. Busy means that another radio is transmitting in the channel. Idle means that another radio is not transmitting in the channel. One method to determine that the channel is idle or busy to use sync pattern detection. Sync pattern detection correlates the received signal with a known sync pattern that is used at the beginning of the transmission of a wireless packet. If the sync pattern is detected, then the radio determines that the channel is busy. Otherwise, the radio assumes that the channel is idle.

If the channel is found idle, the radio transmits the packet immediately. If the channel is found busy, the radio reschedules the packet transmission to some other time in the future, which is chosen with some randomization. This is represented by step 412. Once the scheduled time arrives, it will check against whether the channels is busy at step 408 and, if idle, transmitting it at step 410. If it is busy, it may again reschedule transmission at step 412 and check again at step 408. Although not indicated, the loop can be timed out at some point.

The next steps of process 400, which are optional, depend on whether the packet is a unicast packet or a broadcast packet, as indicated by decision step 414. A unicast packet is one that is addressed to a specific destination radio. A source radio will know a destination's radio address if it has formed an RF link with it. A broadcast packet is one that is not addressed to a specific radio.

If it is not a unicast packet, the radio removes the transmitted packet from the radio's transmit queue at step 416 and returns to step 402 to process the next packet in its transmission queue or to wait to receive one.

If the transmitted packet was a unicast packet, it waits as indicated by steps 418 and 420 for a predetermined period for receipt of a packet from the destination radio that indicates receipt of the transmitted message. When a radio receives a unicast packet addressed to it, the radio acknowledges the reception right after the received packet by either transmitting a wireless packet with the acknowledgement and any data that it may have that can be transmitted to the source radio, or just an acknowledgement if it has no data. If a packet containing an acknowledgement is received from the destination radio before this period “times out,” the radio generates a notification at step 422 that is sent or provided to the communication manager and then removes the packet from its transmission queue at step 416 before returning to the listening to the channel and processing the next wireless packet in its transmissions queue at steps 402 and 404. If, at step 420, an acknowledgement packet from the destination radio is not received before the wait period times out, the radio may, optionally, wait a random period at step 412 and then reattempt transmission one or more times starting with step 408.

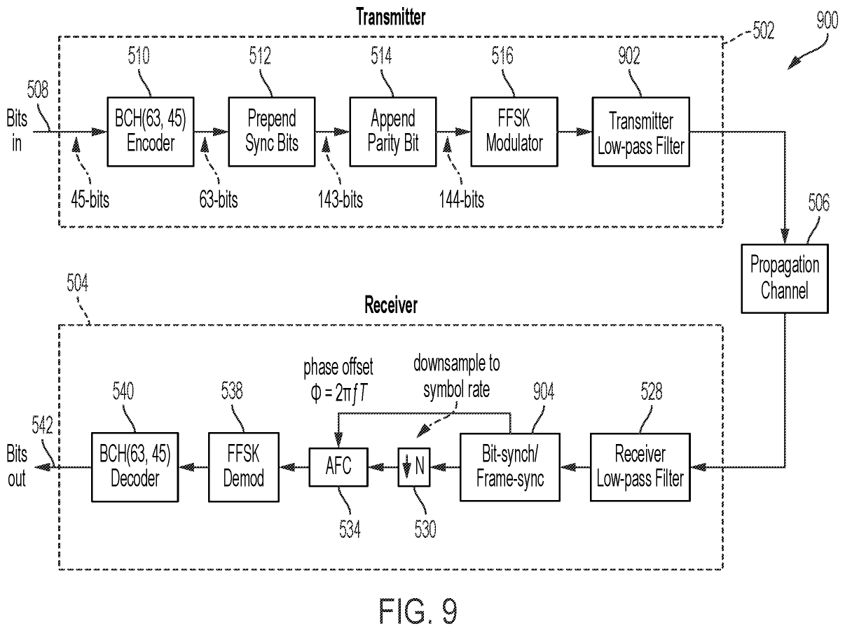

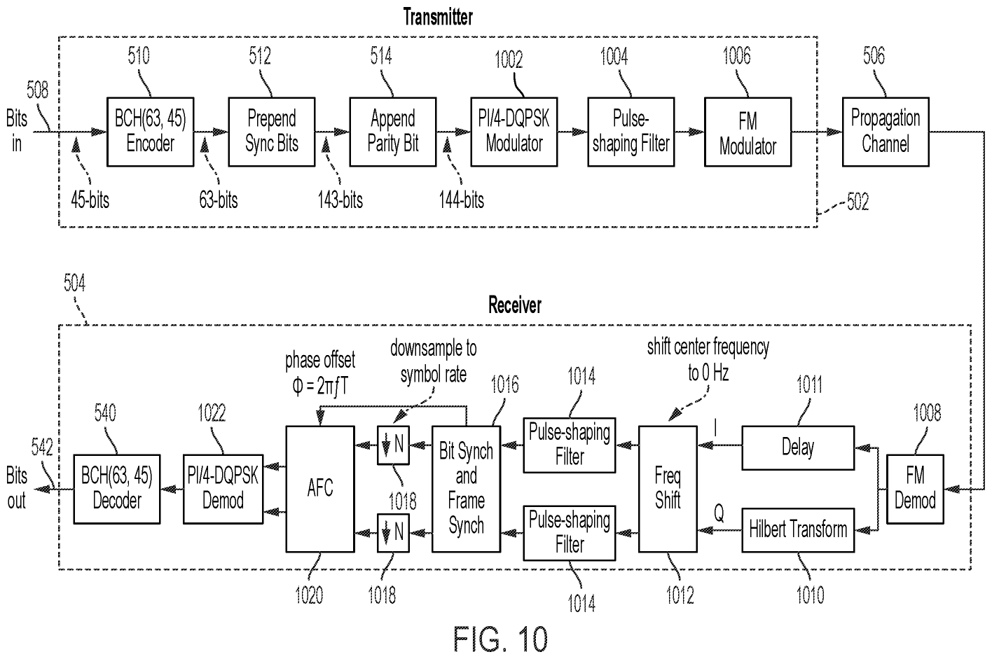

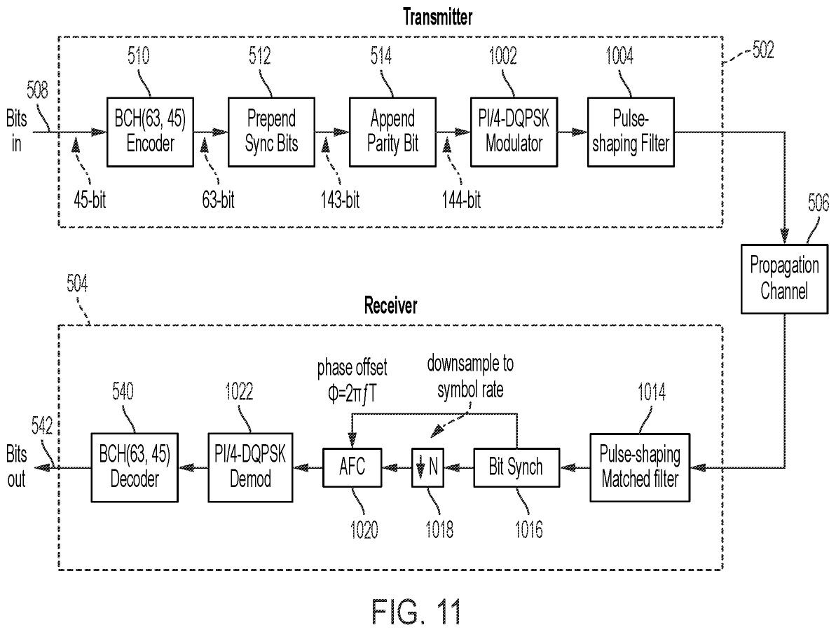

FIGS. 5-12 disclose representative examples of 450 MHz radios for an EOT/HOT communication system. FIGS. 5, 7, 9, 10, and 11 illustrate examples of basic architectures of a 450 MHz radio 500 (FIG. 5), 700 (FIG. 7), 900 (FIG. 9), 1000 (FIG. 10) and 1100 (FIG. 11) that use different types of modulation schemes. FIG. 5 illustrates an example of a 450 MHz radio configured for legacy FFSK-over-FM modulation with a transmit data rate of 1200 bps. The other representative examples shown in FIGS. 7, 9, 10, and 11 are configured to use modulation schemes capable of transmission at higher data rates within the same channel bandwidth as the legacy 450 MHz radio and meet FCC mask requirements are used by. These are FFSK modulation (FIG. 7), “advanced” FFSK modulation (FIG. 9), DQPSK-over-FM modulation (FIG. 10), and DQPSK modulation (FIG. 11). Each 450 MHz radio operates in half-duplex mode but could operate in full duplex mode.

Each of these radios may be implemented as a software defined radio (SDR). An SDR implements some conventional components of a radio, such as modulators, demodulators, filters, and mixers, using software running on a processer or other programmable hardware circuit, examples of which a digital signal processor (DSP), field-programmable gate arrays (FPGA), and general-purpose processors. In addition to hardware for executing the processes, an SDR will also have additional hardware, such as memory for storage, analog amplifiers and filters for its RF stage, analog to digital (ADC) and digital to analog (DAC) converters for converting between radio frequency (RF) (and, if used, intermediate frequency (IF)) analog signals and digitized signals. Examples of analog components include antennas, filters, low noise amplifiers, power amplifiers, variable gain amplifiers (VGAs). FPGAs are semiconductor devices with configurable static random access memory (SRAM), configurable logic blocks or logic arrays, and input/output (I/O) blocks, which can be connected using programmable interconnects. Unlike application-specific integrated circuits (ASICs), which are manufactured for specific tasks, FPGAs can be reprogrammed in the field using a hardware description programming language. FPGAs can operate at very high rates, which enables an SDR radio to receive and transmit on multiple channels simultaneously. A DSP, which is a type of microprocessor configured to process digital signals efficiently, is typically, but does not have to be, used for digital modulation/demodulation, forward error correction, and the encoding and decoding of digital signals. The radio may also include a central processing unit (CPU)—a microprocessor, RAM, and storage memory—that is programmed to manage the SDR.

The schematic diagrams of FIGS. 5, 7, 9, 10, and 11 omit analog RF stages and other components such as antennas, CPUs, and local network interfaces. A digital radio will be connected to one or more antennas to transmit and receive RF signals carrying digital data packets and to a local area network through a network interface to receive digital data packets for transmission and to forward received data packets to a local host of a railroad application, among other functions. The processes of the functional blocks in the schematic diagrams presume that the signals being processed are digital signals, though conventional radio components could be substituted. Digital signals for transmission by the transmitter 502 are converted to an analog RF signal for transmission. An RF signal received by a receiver is also digitized. However, it may optionally be down converted to an intermediate frequency (IF) for sampling.

The functional blocks of the schematic diagrams in FIGS. 5, 7, 9, 10, and 11 can be implemented, for example, using programmed processes on, for example, an FGPA or DSP, by hardware circuits, or a combination of them. For example, baseband signal processing could, optionally, be implemented is using FPGA or DSP programmed to perform the modulation, demodulation, filtering, and other signal processing that is described. Other functional components or process could, optionally, be implemented by software running on a general purpose microprocessor. The choice may depend on factors unrelated to the substance of disclosure.

Elements common to the examples of radios in FIGS. 5, 7, 10, 11, and 12 will be described first. Each as transmitter 502 and a receiver 504. For purposes of discussion, the schematic in each figures includes a transmitter of one radio connected through propagation channel 506 to a receiver in another radio. However, this does mean that radio's transmitter section is transmitting a message to its receiver section.

Unless otherwise indicated, each of the of these examples will be described in reference to a packet structure for transmission that is the same as that used in the legacy 450 MHz two-way communications system. Alternatively, a different packet structure can be used but it might not support transmission or reception of digital RF packets by a legacy 450 MHz radio.

A basic message consists of 45-bits of information. The transmitter 502 receives the basic message on the “Bits in” line 508. The basic message data includes, for example, a packet the L1 header, message data and overhead. The basic message is encoded by an encoding process represented by block 510 for forward error correction using, for example, a Bose-Chaudhuri-Hocquenghem BCH (63, 45) code. As part of this process, the encoder generates this code, which 18-bits long in this example, and appends it to the message data to form 63-bits of encoded data.

Immediately preceding the start of every transmission of a basic message is a series of bits that will be used by the receiver for synchronization. These bits are prepended to the encoded data from block 510 using a process represented by block 512. The prepended bits comprise a bit-sync pattern followed by a frame-sync pattern are immediately before the encoded data. The bit-sync pattern bits enable the receiver to establish symbol and bit synchronization. The bit-synch pattern may consist of a 69-bit sequence of alternating zeroes and ones, such 010101. The bit-sync bits are followed by the frame-synch pattern, which consists of an 11-bit codeword that can be used by the receiver to find the start of the payload frame. Other bit-sync and frame-sync patterns could be used. For example, when using DQPSK-over-FM modulation (FIG. 10), a single 80 bits preamble consisting of a pseudo random sequence in place of the 69 bit sync pattern bit-synch and frame-synch bit patterns performed better. The pseudo random bit pattern of the code word is configured to generate a single distinct correlation peak that identifies both symbol timing and frame timing in the receiver. A trailing bit may be added to the end of the payload to ensure that the receiver can reliably recover the last bit at the end of the encoded payload by a process represented by block 514. The resulting basic message block contains 144 bits in total.

Therefore, the transmitter of each of the radios relies on a different modulation process. The modulation processes are discussed below.

The receiver 504 side demodulates signals transmitted by other radios according to the modulation scheme used by the transmitter. Each of the radios in these examples use non-coherent, differential demodulation to recover the transmitted symbols. Other demodulation methods could be used, including those requiring coherent demodulation. One advantage of noncoherent differential demodulation methods is that coherent methods require precise synchronization of the frequency and the phase of the carrier of the modulated signal. Though frequency synchronization is still needed, noncoherent differential modulation avoids the complexity of having to synchronize with the phase of the carrier for the modulated signal. It also handles better, or is more tolerant of, phase errors and frequency offset in the received signal.

Differential demodulation recovers the transmitted symbols using a phase change during a symbol period. The symbol period is based on the known symbol rate. Each received symbol is then multiplied by the complex conjugate of the preceding symbol to obtain the demodulated symbol. For example, a demodulated symbol is obtained by multiplying a received symbol n by the complex conjugate of the preceding received symbol n−1. The next demodulated symbol, n+1, is obtained by multiplying received symbol n+1 by the complex conjugate of received symbol n. This process is described by yₙ=xₙ₊₁×xₙ*, where xₙ is the nth received symbol and * represents the complex conjugate operation.

After differentially demodulating of the received symbols to obtain the transmitted symbols, a BCH (63, 45) decoder 540 decodes recovered symbols with error correction to recover the basic message. The basic message is then made available by the receiver for further processing as represented by the “Bits out” line 542.

The radios 500, 700, and 900, schematic diagrams of which are shown in FIGS. 5, 7, and 9, respectively, each employ each FFSK modulation and therefore will be described together. Radios 1000 and 1100, schematic diagrams of which are shown in FIGS. 10 and 11, employ Pi/4 DQPSK modulation and will be subsequently described together.

The modulation in transmitter 502 and the demodulation in the receiver 504 of each are similar in each radio in each of the radios except that, FIG. 5, the radio 500 includes an analog FM modulator in the transmitter 502 and demodulation in the radio of FIG. 5 to implement a FFSK-over-FM modulation scheme.

Each of the radios 500, 700, and 900 includes an FFSK modulator 516 in the transmitter 502 that is switched by the bits of the basic message block at a predetermined symbol rate. A bit stream of the basic message block switches the frequency of a continuous wave between two frequencies, one representing a bit value of “0” and the other representing a bit value of “1” at the symbol rate. The receiver 504 of each radio 500, 700, and 100 each includes an FFSK demodulator demodulate the FFSK modulation in the received signal.

Unlike radios 700 and 900, radio 500 uses the continuous waveform from the output of FFKS modulator 516 as an analog baseband signal to frequency modulate a carrier signal using the analog FM modulator 538. The modulator produces a carrier signal modulated by this baseband signal that is transmitted through the propagation channel 506.

The FFSK modulating frequencies for the FFSK modulator 516 of the radio 500 FIG. 5 are 1200 Hz for a 1, and 1800 Hz for a 0 to comply with AAR S-9152. The maximum symbol or baud rate at which the bits are transmitted is limited to 1200 bits/s. The modulation generates a real-valued band-pass signal with a center frequency of 1500 Hz. This signal is the analog input signal that the analog FM modulator 528 uses to frequency modulate a carrier frequency. The current version of AAR S-9152 specifies that the deviation between the mark (bit 1) and space (bit 0) frequencies of the FM modulated signal should be no more than +/−3 kHz and that the waveform should comply with the applicable FCC emissions mask.

In contrast to transmitter 502 of radio 500 in FIG. 5, the transmitter 502 in the radios 700 and 900 illustrated by FIGS. 7 and 9 transmit directly the continuous waveform produced the FFSK modulator. One example of an FFSK waveform is a complex-valued baseband signal with I and Q components, with center frequency of 0 Hz (relative to the carrier), and with mark-space frequencies of −300 Hz and +300 Hz. As such, it is smaller than the +/−3 kHz used by the legacy system.

A difference between FFSK modulation and legacy FFSK over FM modulation is that the FM version is transmitted over a much larger bandwidth as compared to the bandwidth of the underlying baseband waveform. The null to null bandwidth of the FFSK waveform is equal to 1.5× the symbol rate, which means that a 1200 baud FFSK waveform of radio 500 has a null to null bandwidth of 1800 Hz. This much smaller than the 12.5 kHz bandwidth channel that is used to transmit the FFSK over FM waveform.

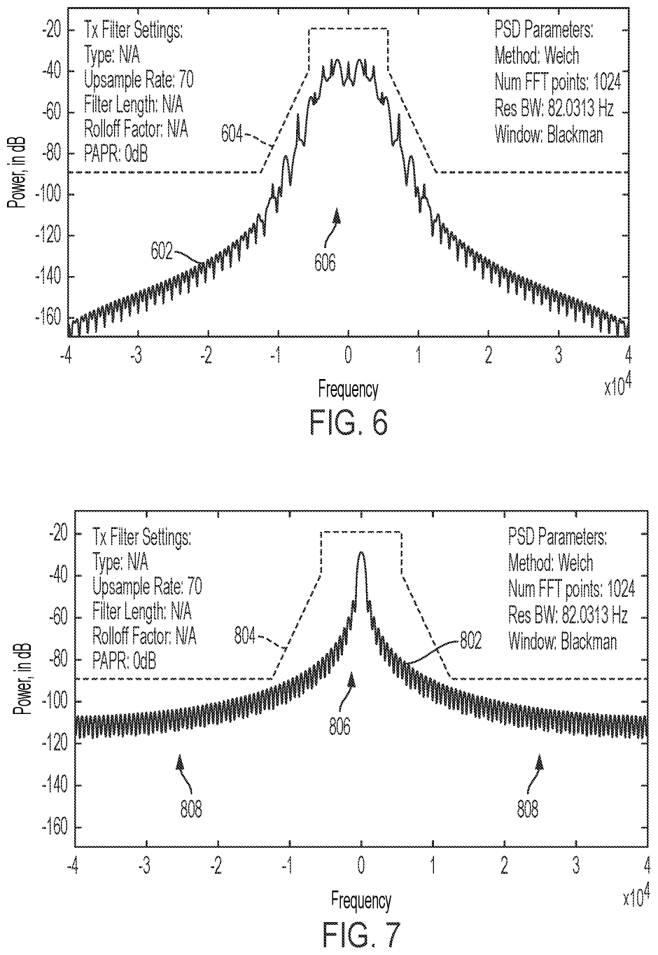

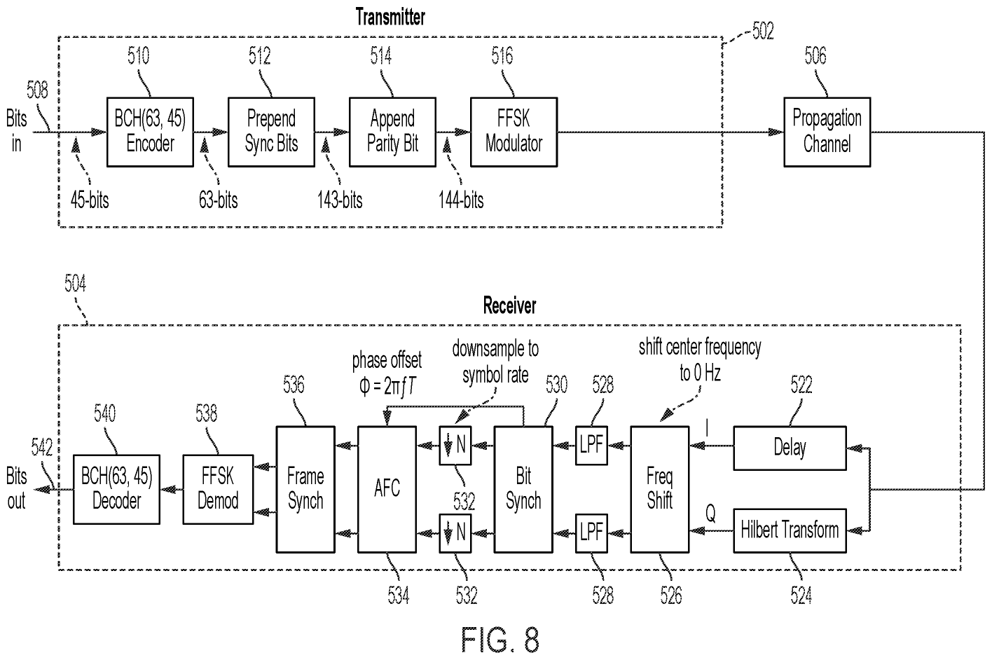

Referring briefly to FIGS. 6 and 8, these figures illustrate the frequency spectrums of an FFSK-over-FM waveform and an FFSK wave form at the symbol rate of 1200. The frequency spectrum 602 of a FFSK-over-FM waveform simulated using MSK over FM (MSK is a type of FFSK modulation) at a symbol rate of 1200 is well with the applicable Federal Communications Commission (FCC) Emission Mask D 604. Even though width of the main lobe 606 is relatively wide given the relatively low data rate, spectrum fits comfortably within the emission mask 604. The frequency spectrum 802 of FFSK waveform at a symbol rate of 1200 symbols per second is simulated using complex valued I/Q waveform with a single sided spectrum centered at zero Hz. The main lobe 806 of the FFSK spectrum is much narrower than the FFSK over FM spectrum. However, the sidelobes 808 of the FFSK spectrum are relatively high, such that the waveform only just satisfies the emission mask 804, even though the main lobe is so narrow.

Referring briefly only to FIG. 9, the sidelobes 808 could be reduced, if necessary, using low pass filter. Unlike radio 700 of FIG. 7, the radio 900 includes a low pass filter 902 that receives the FFSK waveform from the FFSK modulator 516 in the transmitter section. The lower pass filter has cut-off frequency that is a fraction of the symbol rate to reduce the possibility of introducing an unacceptable level of inter-symbol interference (ISI). In this example, the cut-of frequency is 0.625 times the symbol rate. However, other cut-off frequencies could be used if found to provide satisfactory performance.

Referring again to FIGS. 5-9, the receiver 504 in radios 500, 700, and 900, each receiver demodulates the FFSK signal in a substantially similar way. However, the receiver 504 of radio 500 must process a received signal using FM demodulator 520 to recover the real value band pass signal containing the FFSK waveform before FFSK demodulation can occur.

Noncoherent differential demodulation is used in each receiver 504 to demodulate the FFSK modulated baseband signal. Note that the schematic diagram of radio 900 illustrated in FIG. 9 omits for simplification any indication that the demodulation of signals containing an FFSK waveform uses separate I and Q components, and therefore also omits illustrating the separation of the signal into I and Q components. However, this does not imply it is not being done. The process of demodulation of the FFSK waveform by the receiver 504 of radio 900 is substantially the same as the process in the receivers of radios 500 and 700.

The real value band pass signal with the FFSK waveform is sampled. I and Q quadrature components of the signal are generated using the Hilbert Transform. The Hilbert Transform of the original signal generated by the Hilbert Transform process 524 is used as the Q component. The original signal is used as the I component after it is passed through delay 532. The I component has a two-sided frequency spectrum. Combining it with the output of the Hilbert transform generates a complex valued analytic signal with a single sided frequency spectrum.

Because the samples of the I and Q samples are still centered at 1500 Hz, the center frequency is shifted to 0 Hz, which is possible without aliasing because the analytic signal has a single sided spectrum The shifting is achieved by a process, represented by frequency shift bock 526, in which the I and Q components are multiplied by the complex signal e^{-j2πf}^{_{b}}^{nT}^{ₛ}, where f_{b} is the center frequency of the baseband signal and Tₛ is the sampling period.

The signal from the frequency shift block 526 may have substantial out of band noise due to the large bandwidth of the signal relative to the FFSK waveform. Since the waveform is now centered at 0 Hz, a low pass filter (LPF) 528 is used to reduce the amount of out the out of band noise in I and Q components of the signal. All the subsequent signal processing after the low pass filters is done using differential samples.

Bit synchronization is carried out by a bit synchronization process represented by bit synchronizer 530 using bit-sync bits the transmitted message block. In the example given above, these are the sixty-nine bits of alternating 1s and 0s at the beginning of basic message. To obtain bit synchronization, a local reference is generated by FFSK modulating the bit sync sequence to form 69 complex valued symbols. The local reference is then differentially demodulated to form a differential phase version of the transmitted bit sync symbols. The received signal is then differentially demodulated, and a cross-correlation process is performed using the phase differential input waveform and the phase differential local reference. The cross correlation is performed at the symbol rate but repeated at sample intervals. This forms a series of peaks that repeats at symbol intervals. The repeating pattern occurs because the bit sync sequence is a repeating bit pattern. The positions of the peaks provide the symbol timing. For example, if the FFSK waveform was sampled using and ADC prior to being separated into I and Q components using the Hilbert Transform 524 at a rate of 10 samples per symbol, the correlation peaks will occur every 10 samples.

Following the bit synchronization stage, the input samples for the I and Q components of the baseband signal are then down sampled to the symbol rate using a receiver process represented by down sampling block 532, one for each I and Q channels. All subsequent signal processing can then be performed at the lower sampling rate.

The bit synchronization process calculates a frequency offset on the received symbols. The frequency offset is passed to automatic frequency correction (AFC) process represented by block 534, which de-rotates the symbols according to the estimated offset frequency. The frequency offset is estimated by determining the phase rotation on the received symbols, after performing differential demodulation, according to the relationship ϕ=2π∫T, where ϕ us estimated frequency offset. The estimated offset frequency is provided to the AFC. The AFC corrects the frequency offset by multiplying the I and Q components of the differential symbols by the complex number e^{-jϕ}.

Frame synchronization then occurs using a process represented by frame synchronization block 536. Frame synchronization identifies the start of the payload in the bit stream.

Differential demodulation of the basic message using the down sampled I and Q components of FFSK signal uses the FFSK demodulation to recover the transmitted symbols in the payload and then differentially demodulating using timing as determined by bit synchronizer 530. The demodulation process represented by FFSK modulator 538. After demodulation there are just four possible sets of I and Q values, depending on the received symbols. Because the symbols are 1 bit, converting the differential symbols to their corresponding bits is straightforward process as it only depends on the signs of the I and Q components. The bits are then decoded using the BCH (63,45) decoder 540 to produce a recovered bit stream.

Turning now FIGS. 10 and 11, radios 1000 and 1100 implement Pi/4 DQPSK modulation. Differential phase shift keying (DQPSK) represents a transmitted symbol using the phase of the carrier wave. Pi/4-DQPSK adds to the four ideal states of DQPSK a Pi/4 offset for a total of eight. The ideal state positions for symbols alternate between the four 45-degree states normally used by QPSK and four on-axis states. Due to this alternation, the ideal trajectory between symbols never crosses through zero. There are 4 possible phase changes between symbols, each representing 2 bits of information. The following table shows the mapping of phase change to bit pattern for Pi/4-DQPSK:

| Phase Change | Bit Pattern |
|---|---|
| Pi/4 | 00 |
| 3PI/4 | 01 |
| −Pi/4 | 10 |
| −3PI/4 | 11 |

In each transmitter 502 the basic message block with the parity bit is passes it to a Pi/4-DQPSK modulator 1002, which produces a digital signal that is modulated using Pi/4-DQPSK, producing a Pi/4 DQPSK modulated waveform that a complex valued I/Q waveform with a center frequency of 0 Hz.

In radio 1110, this waveform is then up sampled and filtered using pulse shaping filter 1004. Root Nyquist transmit filter with a length of 16 symbols may be used as the pulse shaping filter. The transmitter 502 of radio 1100 then transmits the resulting waveform.

In radio 1000, the digital output signal of the Pi/4-DQPSK modulator 1002 is passed through a square root raised cosine pulse shaping filter before being frequency modulated by FM modulator 1006. Because an FM modulator requires a real-valued input waveform, the center frequency is the signal shifted to form a real valued band pass signal prior to being modulated by the FM modulator 1006. A center frequency of 750 Hz provides was good performance with the Pi/4 DQPSK waveform. However, other center frequencies could be used. The band pass signal is the modulated with the FM modulator 1006 using analog Frequency Modulation (FM). The maximum frequency deviation should be no more than +/−3 kHz, and the waveform should comply with the FCC emissions mask.

Referring now only to FIG. 10, after the radio 1000 receives a Pi/4-DQPSK-over-FM signal, which can be the RF signal or, if down-converted, an IF signal that is sampled, the receiver 504 demodulates a sampled Pi/4-DQPSK-of-FM signal FM demodulator 1008 to recover a real-valued band-pass signal containing the Pi/4-DQPSK waveform. At this point in the digital signal processing chain, immediately after the FM demodulator, significant out-of-band noise may be present because the real-valued band-pass signal has been over-sampled, and its bandwidth is much larger than the bandwidth of the Pi/4-DQPSK waveform.

Referring to FIGS. 10 and 11, the demodulation of the Pi/4-DQPSK over FM modulation signal is substantially the same in the receiver 504 of radios 1000 and 1100.

I and Q quadrature components are generated of the signal containing the Pi/4-DQPSK waveform using a Hilbert Transform 1010. This signal is the demodulated signal is the real-value band-pass signal The generation and subsequent processing of I and Q components by the receiver 504 of radio 1100 are omitted from the schematic shown in FIG. 11. Radio 1100 is, nevertheless, performing all baseband processing on sampled I and Q components for purposes of differential demodulation. Taking the original signal, which has a two-sided frequency spectrum, delaying it with delay process 1011 and combining it with the output of the Hilbert transform 1010 generates a complex-valued analytic signal with a single-sided frequency spectrum.

Because the I and Q samples are still centered at 750 Hz, the center frequency is shifted to 0 Hz using frequency shifter 1012. This is possible without aliasing because the analytic signal has a single sided spectrum. The process of frequency shift 1012 multiplies the I and Q components by the complex signal e^{-j2πf}^{_{b}}^{nT}^{ₛ}, where fb is the center frequency of the baseband signal and Tₛ is the sampling period. The signal at this point may still have significant out of band noise due to its large bandwidth relative to the Pi/4-DQPSK waveform. Because the waveform is now centered at 0 Hz, low pass pulse-shaping matched-filters 1014 for the I and Q components are used to recover I and Q components of a baseband signal.

As mentioned above, better performance could be obtained for Pi/4-DQPSK modulated wave forms when a single pseudo random bit-pattern is used in place of the legacy bit-sync and frame-sync patterns in the preamble of the transmitted packet. Bit synchronization and frame synchronization are therefore obtained simultaneously using the process represented by Bit Sync and Frame Sync block 1016. With timing recovered and the start of the payload frame identified, the baseband I and Q signals are then demodulated.

As with the FFSK demodulation process discussed above, the I and Q components of the baseband signal are then down-sampled using a down-sampling processes of the receiver, which are represented by block 1018, to the symbol rate. They are then frequency corrected using an automatic frequency correction process represented by AFC 1020. The bit synchronization process calculates a frequency offset on the received symbols. The frequency offset is passed to automatic frequency correction (AFC) process represented by block 534, which de-rotates the symbols according to the estimated offset frequency. The frequency offset is estimated by observing the phase rotation on the received symbols, after performing differential demodulation, using ϕ=2π∫T, which the bit synchronizations process provides to the AFC. The AFC corrects the frequency offset by multiplying the I and Q components of the differential symbols by the complex number e^{-jϕ}.

After correcting for frequency offset, the beginning of the frame of baseband signal is demodulated using a Pi/4 DQPSK demodulator 1022 according to the bit synchronization timing recover the transmitted symbols and differentially demodulate. These symbols are passed to the BCH (63,45) decoder 540 to recover the bits of the basic message, as represented by the “bits out” line 542.

Optionally, a 450 MHz radio implementing a higher data rate modulation scheme, such as any one of the one or more embodiments of FIGS. 7, 9, 10, and 11, may be configured to support legacy FFSK-over-FM modulation in addition to any one or more of the higher data rate modulation schemes. As mentioned above, legacy 450 MHz radios—those currently in use—are analog and use a frequency modulated output stage. One representative example of how to adapt a higher data rate 450 MHz radio, such as those described above, to also support communications with a legacy 45 MHz radio, comprises providing a transmitter section of an SDR-implemented 450 MHz radio with a separate analog FM output stage for legacy 450 MHz transmissions. Alternatively, an SDR-implemented 450 MHz radio can be programmed to switch modulation schemes to synthesize a digital version of the analog FM waveform using a digital I/Q modulator. The receiver section of the radio may, for example, implement FM demodulation digitally, such as done in the embodiment of FIG. 10.

Unless explicitly stated otherwise, the foregoing description of examples and embodiments, including preferred embodiments, are representative and non-limiting examples implementations, embodiments, and uses of various features for purposes of disclosing and explaining claimed subject matter to those skilled in the art and how it can be practiced. The meaning of the terms used in this specification are, unless otherwise explicitly defined, intended to have their ordinary and customary meaning to those skilled in the relevant art. The meanings of the terms are not limited by the specific structures of the examples and embodiments. Alterations and modifications to the disclosed embodiments can be made without departing from the scope of subject matter claimed below.

What is claimed is:

1. A communication system for wirelessly communicating between an end of train (EOT) area of a train and a head of train (HOT) area message data from a railroad application in a narrowband channel in a 450 MHz frequency band, the system comprising:
at least one digital radio comprising a transmitter and a receiver;
wherein the transmitter is configured to modulate according to a digital modulation scheme and transmit wirelessly data packets having a predetermined format in the narrowband channel at a data rate higher than 1200 bps; and
wherein the receiver is configured to receive wirelessly transmitted data packets and demodulate the data packets according to the digital modulation scheme;
wherein the digital modulation scheme is from a group of modulation schemes consisting of FFSK, FFSK with digital FM modulation, DQPSK modulation, Pi/4 DQPSK over FM modulation, and D8PSK modulation.

2. The communication system of claim 1, wherein the digital radio determines whether the narrowband channel is idle before transmitting a data packet that it receives for transmission and immediately transmits the data packet if it determines that the narrowband channel is idle and reschedules the transmission of the data packet for a later time if it determines that the narrowband channels is busy.

3. The communication system of claim 1, wherein the digital radio is configured to wait a predetermine period after it receives of a data packet for transmission before determining whether the channel is idle.

4. The communication system of claim 1, wherein the digital radio is configured to enable the digital radio to switch from the digital modulation scheme to a legacy FFSK over FM transmission modulation scheme to transmit a data packet to a legacy radio.

5. The communication system of claim 1, wherein a preamble for symbol synchronization is prepended to the data packets prior to transmission.

6. The communication system of claim 1, wherein each data packet that is transmitted contains a preamble for enabling symbol synchronization, a physical layer header, and a payload portion that includes message data and overhead information.

7. The communication system of claim 6, wherein the overhead information in each data packet includes forward error correction information.

8. The communication system of claim 6, wherein the overhead information includes a layer 2 address for identifying a destination radio.

9. The communication system of claim 1, wherein the data packets are formatted according to published standard AAR S-9152.

10. A method for wireless communication between an end of train (EOT) area and a head of train (HOT) area comprising:
determining whether a narrowband channel in a 450 MHz frequency band is idle;
if the channel is idle, immediately transmitting a data packet using a digital modulation scheme at a data rate higher than 1200 bps while complying with applicable emission mask requirements, the digital modulation scheme is from a group of digital modulation schemes consistent of a FFSK, FFSK with digital FM modulation, DQPSK modulation, Pi/4 DQPSK over FM modulation, and D8PSK modulation; and
if the channel is busy, rescheduling transmission of the data packet for a later time.

11. The method of claim 10, wherein the digital radio determines whether the narrowband channel is idle before transmitting a data packet that it receives for transmission and immediately transmits the data packet if it determines that the narrowband channel is idle and reschedules the transmission of the data packet for a later time if it determines that the narrowband channels is busy.

12. The method of claim 10, wherein the digital radio is configured to wait a predetermine period after it receives of a data packet for transmission before determining whether the channel is idle.

13. The method of claim 10, wherein the digital radio is configured to enable the digital radio to switch from the digital modulation scheme to a legacy FFSK over FM transmission modulation scheme to transmit a data packet to a legacy radio.

14. The method of claim 10, wherein data packet that is transmitted contains a preamble for enabling symbol synchronization, a physical layer header, and a payload portion that includes message data and overhead information.

15. The method claim 14, wherein the overhead information includes a layer 2 address identifier a destination radio.

16. The method of claim 1, wherein the data packets are formatted according to published standard AAR S-9152.

17. A software defined radio for wirelessly communicating between end of train (EOT) and head of train (HOT) areas of a train, comprising a transmitter and a receiver, each configured to transmit and receive data packets in a narrowband channel in a 450 MHz frequency band;
wherein the transmitter comprises a modulator configured to modulate data packets using a digital modulation scheme with a data rate greater than 1200 bps while complying with FCC emissions mask requirements and the receiver comprises a demodulator configured to demodulate received data packets modulated using the digital modulation scheme; and
wherein the digital modulation scheme is selected from a group of digital modulation schemes consisting of a FFSK, FFSK with digital FM modulation, DQPSK modulation, Pi/4 DQPSK over FM modulation, and D8PSK modulation.

18. The method of claim 17, wherein data packets contain a preamble for enabling symbol synchronization, a physical layer header, and a payload portion that includes message data and overhead information.

19. The method of claim 17, wherein the data packets are formatted according to published standard AAR S-9152.
